(19) United States
(12) Patent Application Publication
(10) Pub. No.: US 2019/0112521 A1
(43) Pub. Date: Apr. 18, 2019

(54) Friction Reduction and Suspension in High TDS Brines

(71) Applicant: PFP Technology, LLC, Katy, TX (US)

(72) Inventors: Robert McDaniel, Cypress, TX (US); Madhukar Chetty, Houston, TX (US)

(73) Assignee: PFP Technology, LLC, Katy, TX (US)

(21) Appl. No.: 15/786,769

(22) Filed: Oct. 18, 2017

(51) Int. Cl. C09K 8/88; C09K 8/80

(52) U.S. Cl. CPC C09K 8/882; C09K 2208/28; C09K 8/805

(57) ABSTRACT

A friction-reducing additive composition that contains a polymeric mixture containing (a) a first polymeric friction reducer that comprises an anionic friction reducer having a molecular weight above 15 million and (b) a second polymeric friction reducer that is either a nonionic or an amphoteric friction reducer. This combination of friction reducers exhibits superior suspensive characteristics for hydrophobically coated proppants in high TDS brines, such as those that reuse fracturing fluids or backwaters. Optionally, gaseous nitrogen can be generated downhole or in the treated field by introducing a two-part system of reactants that chemically interact so as to produce gaseous nitrogen bubbles that help to suspend hydrophobically coated proppants and provide an additional method to control proppant placement within a treated subterranean field.

### FIELD OF THE INVENTION

This invention relates to various aspects of improving the utility and performance of a technology designed to maximize the placement of proppant in a hydraulically induced fracturing treatment.

### BACKGROUND OF THE INVENTION

Boreholes in subterranean formations are often treated via hydraulic fracturing to increase their conductivity in order to enhance recovery of hydrocarbons. The fracturing procedure increases flow by creating highly conductive new fissures and facilitating the connectivity of the existing pores and natural channels contained in a reservoir rock that would otherwise not allow adequate flow to reach the wellbore in sufficient quantities for commercial value.

Hydraulic fracturing cracks or “fractures” in the adjacent substrate or zone are created by forcing a fluid at a rate and pressure that exceeds the parting pressure of the rock. The continued injection of the fracturing fluid expands the fractures. As the pumping pressure at the surface is released, the fracturing fluid will retreat from the formation back to the well. When the pumping process is stopped the fluid (containing proppant) left in the created fractures will leak off into the formation rock until the fracture faces close onto the proppant that is left behind. Proppant incorporated in the fluids is left behind and acts to prevent the expanded fractures from closing, allowing the conductive channels to remain. The viscosity of fracturing fluids is important for the creation of a pumping fracture width and for transporting the proppant material into the fractures. Poor or low viscosity can lead to “premature screen out” whereby the proppant fills up all the available volume of the created fracture and wellbore which in turn will lead to a build-up in pumping pressure that will cause the treatment to be terminated. This premature termination significantly impairs the ability to extend the fractures deeper into the formation. High viscosity of the fluids is required to transport most proppant, especially high concentration of proppant, and this viscosity is typically achieved by cross-linking polymer solutions.

It is the combination of viscosity and pump rate that creates the fracture geometry in a treatment. If you are going to use a thin fluid, as in what are called “slickwater” treatments, you must use high pump rates to ensure you can create sufficient fracture volume and to transport the proppant out into the fracture. If you don't want to or can't pump at high rates then you can generate the necessary fracture volume and transport the proppant (at lower rates) by increasing the viscosity of the fracturing fluid. Crosslinking a polymer solution is an industry accepted way to generate a substantial increase in viscosity.

Slickwater fracturing, different from fracturing using cross-linked fluids, has been developed and used in tight gas sand reservoirs since 1997. Because of the very low viscosity of the fluid, the operations achieve proppant transport by increasing pumping rates and pressure, which causes significant energy loss due to friction between tubular goods and the turbulent fluid flow. This requires extra energy (hydraulic horsepower) to compensate the energy loss. High molecular weight (typically over 10 M) polymers are used as friction reducers to minimize the energy loss by changing turbulent flow to laminar flow via interactions with eddies of turbulent flow.

Typical friction reducer additives for a fracking fluid include one or more anionic acrylamide homopolymers or copolymers in low viscosity fracturing fluids known as slickwater fluids, which typically contain only 0.025 to 0.2 weight percent of the friction reducer, in addition to other conventional additives such as biocides, scale inhibitors, clay stabilizers such as potassium chloride or trimethylammonium chloride. Friction reducers are available in oil or oil-and-water emulsions. Although anionic friction reducers are most often used, there are also nonionic and cationic options that may be preferred in certain applications, particularly in waters containing a high TDS. Although most friction reducers are in a liquid form, e.g., as emulsions or suspensions, some are used in their dry form. See generally U.S. Pat. Nos. 3,710,865; 5,027,843; 8,044,000; 8,575,073; and 9,034,802 the contents of which are hereby incorporated by reference.

To reduce turbulent flow in the slickwater fluid, the friction reducer must “flip” from the emulsion to rapidly dissolve in the water, usually within several seconds, or else the full drag reduction will not be achieved during transit through the wellbore. Surfactants have been used in the friction reducer emulsions to shorten the flip time. Also, dilution of the friction reducer in a brine solution has been used to collapse ionic polymer chains and reduce the viscosity of the concentrated friction reducer solution; however, storage stability has been an issue because any contact with fresh water, such as condensate dripping inside a storage tank, immediately forms fisheyes, which cannot be redispersed.

There is a trend developing within the North American hydraulic fracturing market. That being to utilize a produced back water as part of the base fluid to be used in a fracturing treatment. This trend will significantly increase the total dissolved solids (TDS) of the water to be used in the fracturing treatment. Due to this trend it has become important to verify that fracturing systems, underlying technologies, and additives can function effectively in brines or brine/fresh water mixtures where the TDS may be 50,000 ppm or higher. Some waters used in fracturing operations contain in excess of 200,000 ppm TDS.

One issue that has been found to be critical to maximizing the production increase that is attained through hydraulic fracturing is how much of the created fracture will contain proppant that is capable of keeping the fracture open and conductive after the fracturing treatment has been completed and the walls of the created fracture try to close to their pre-treatment positions. To keep the fracture open and conductive proppant must be present. It is therefore imperative that there be a method to maximize proppant transport to ensure that as much of the created fracture contains proppant by the time the treatment has been completed.

The growth in the use of slick water designed treatments was driven by the understanding that the formations being stimulated respond best to long narrow proppant packed fractures. Based on this understanding, the trend is to move away from viscous crosslinked fracturing fluids that primarily result in shorter and wider fractures. However switching to fracturing designs that use thin fluid with poor proppant transport properties has forced the industry to increase fracture fluid volumes and treatment injection rates to carry and place proppant as far out into the formation as possible. Ideally a better result could be obtained if you could combine a low viscosity fracturing fluid (necessary to create long thin fractures) with an improved proppant transport property capable of maximizing the placement of proppant far out into the created fracture matrix.

One fracturing technology that has been found to improve the proppant transport properties of slick water systems is a hydrophobic proppant coating offered by Preferred Sands of Radnor, Pa. under the name FloPRO™. See published application US 2016/0333258, the disclosure of which is hereby incorporated by reference. As noted in this published application, such coatings are made with polymers having functional groups or side chains that contain aliphatic methyl, ethyl, propyl, butyl and higher alkyl homologs. Useful polymers also include those with fluoro groups that impart low surface energies and oleophobic as well as hydrophobic characteristics. Examples of such polymers include trifluoromethyl, methyldifluoro, and vinylidene fluoride copolymers, hexafluoropropyl-containing polymers, side chains that contain short chains of fluoropolymers and the like. Commercially available fluorosilicones can also be used. Examples of hydrophobic polymers include, but are not limited to, polybutadienes. Examples of such polybutadienes include, but are not limited to, non-functionalized polybutadienes, maleic anhydride functionalized polybutadienes, hydroxyl, amine, amide, keto, aldehyde, mercaptan, carboxylic, epoxy, alkoxy silane, azide, halide terminated polybutadienes, and the like, or any combination thereof. One non-limiting example includes those sold under the tradename POLYVEST (from Evonik Industries in Parsippany, N.Y.).

In some embodiments, the hydrophobic polymer may be a di-, tri-, or ter-block polymers or a combination thereof that are terminated with hydroxyl, amine, amide, mercaptan, carboxylic, epoxy, halide, azide, or alkoxy silane functionality. Examples of such diblock and triblock or terblock polymers backbone are not limited to styrene butadiene, acrylonitrile butadiene styrene, acrylonitrile butadiene, ethylene-acrylate rubber, polyacrylate rubber, isobutylene isoprene butyl, styrene ethylene butylene styrene copolymer, styrene butadiene carboxy block copolymer, chloroisobutylene isoprene, ethylene-acrylate rubber, styrene-acrylonitrile, poly(ethylene-vinyl acetate) polyethyleneglycol-polylactic acid, polyethyleneglycol-polylactide-co-glycolide, polystyrene-co-poly(methyl methacrylate), poly(styrene-block-maleic anhydride), poly(styrene)-block-poly(acrylic acid), Poly(styrene-co-methacrylic acid, poly(styrene-co-a-methylstyrene), poly(.epsilon.-caprolactone)-poly(ethylene glycol), and styrene-isoprene-styrene.

The technology used to make the FloPRO hydrophobic coating appears to attract and retain gas bubbles on the surface of the coated proppant. The formation of a gas bubble layer on the proppant's surface would decrease the proppant particle's weight making it easier to suspend and transport. Thus, treatments for using the hydrophobic proppant require the presence of a gas in the slurry being pumped. The need to have a gas in the slurry requires that special high pressure pumping equipment be utilized during the pumping process to meter in the gas at a predetermined rate.

While the proppant suspension properties of the FloPRO coating apparently are not greatly affected by increases in TDS (example 10 in US 2016/0333258 found the hydrophobically coated proppant effective in brine of 10,000 ppm with a transport similar to tap water), the same can't be said for friction reducers (FRs) which also exhibit suspensive properties and that are directed for use with the hydrophobic FloPRO coatings. FloPRO is incompatible with cationic friction reducers so the most brine tolerant FRs are not an option. Anionic friction reducers are compatible but are affected by increased TDS. Not only is this the case for the friction reducer's own properties (such as viscosity build-up) but perhaps more importantly the suspension properties that are achieved when the FloPRO treated sand is added to a high TDS fluid containing a friction reducer and gas.

In particular, the efficacy of the anionic polyacrylamide friction reducers that are used with FloPRO proppants are substantially affected by the highly cationic environment of brines with high TDS levels, such as those exhibiting total dissolved solids levels of 50,000 ppm or more.

It would be desirable to have a friction reducer composition that can be added to a slickwater fracturing fluid that retains its low friction characteristics in brines having total dissolved solids of 50,000 ppm or more and still be able to maximize the suspension properties when used in combination with the FloPRO coated sand.

### SUMMARY OF THE INVENTION

It is an objective of the invention to provide a rheology modifier for slickwater solutions that exhibits a low viscosity and good suspension properties for coated proppants in brine solutions of high TDS, e.g., 50,000 ppm or more total dissolved solids.

It is further an objective of the invention to provide a rheology modifier and friction reducer for use with proppants having a hydrophobic coating that are capable of helping maximize proppant suspension.

In accordance with the above objectives and others that will become apparent from the description herein, a friction-reducing composition according to the invention is useful when treating a subterranean formation penetrated by a wellbore and fractured with a brine fracturing fluid having 50,000 ppm total dissolved solids or more. The friction-reducing composition comprises a polymeric mixture that contains (a) a first polymeric friction reducer that comprises an anionic friction reducer having a molecular weight above 15 million and (b) a second polymeric friction reducer that comprises either a nonionic or an amphoteric friction reducer. The concentration ratio of said first friction reducer to said second friction reducer in said fracturing fluid is within the range of 1:2 to 2:1 and in a total mixture amount that is less than about 5% by weight of the brine fracturing fluid.

Also contemplated by the present invention is a method for stimulating a fractured subterranean field by a process that comprises: inserting proppant into said fractured subterranean field with brine and a polymeric friction-reducing composition that comprises a mixture of polymeric friction reducers comprising (a) a first friction reducer that comprises a high molecular weight, anionic, polymeric friction reducer having a molecular weight above 15 million and (b) a second friction reducer that comprises either a nonionic or an amphoteric polymeric friction reducer, a concentration ratio of said first friction reducer to said second friction reducer in said fracturing fluid that is within the range of 5:1 to 1:1 and in a total mixture amount that is less than about 5% by weight of the brine fracturing fluid.

The polymeric mixture according to the present invention ameliorates the adverse effects of high TDS brine solutions, such as when backwater is used in the fracturing fluid, on the friction-reducing polyacrylamides traditionally used with proppants. The polymeric mixture is especially useful with proppants that have a hydrophobic coating that is incompatible with conventional brine-resistant cationic friction-reducing polymers.

It is a further objective of this invention to simplify the execution of the treatment designed to place the hydrophobic coated proppant in the fracture and to lower the treatment cost by eliminating the need to have a gas source and its associated high pressure pumping equipment on the well location during the execution of the fracturing treatment. This is accomplished by meeting the gas requirement through a chemical reaction between salt solutions that can take place during the pumping process. The addition of the salt solutions to the slurry being pumped can be accomplished by utilizing equipment that is standard to the fracturing operation and already available onsite for their use.

### DETAILED DESCRIPTION OF THE INVENTION

The friction-reducing additive composition is made with a polymeric mixture containing (a) a first friction reducer that comprises an anionic friction reducer having a molecular weight above 15 million and (b) a second friction reducer that comprises either a nonionic or an amphoteric friction reducer.

Suitable polymers that exhibit friction-reducing properties include a wide variety of materials including homopolymers and copolymers containing polar groups and having a range of molecular weights from standard (10-12 million) to high (above 15 million). A wide range of polymers and copolymers of friction-reducing polymers can be used in the invention including polyacrylamides, polyalkylene oxide polymers and copolymers, copolymers of acrylamide and acrylate esters, copolymers of acrylamide and methacrylate esters, copolymers of acrylamide and polymers or copolymers of ethylene oxide and/or propylene oxide, mixtures of polyacrylamide polymers and polymers of ethylene oxide and/or propylene oxide, polyvinyl acetates, vinyl sulfonic acid polymers and derivatives thereof.

A particularly preferred class of polymers are the polyacrylamides and derivatives thereof. These polymers can be obtained by polymerizing acrylamide with or without suitable comonomers to prepare essentially linear acrylamide polymers. Usually the polymerization is conducted under the influence of a chemical polymerization catalyst such as benzoyl peroxide. These acrylamide polymers are water soluble. In the instance of polyacrylamide, the polymer may be used as obtained after polymerization or the polyacrylamide may be partially hydrolyzed by the reaction thereof with a sufficient amount of a base, such as sodium hydroxide, to hydrolyze a portion of the amid groups present in the polymer molecule.

The high molecular weight anionic polymers preferred for the present invention preferably exhibit a molecular weight of above 15 million, preferably a molecular weight within the range from about 18 million to about 40 million, and even more preferably within a range from about 18 million to about 25 million. Most standard polymers useful as friction reducers for oil and gas field stimulation exhibit a molecular weight within the range of 10-12 million.

Nonionic and amphoteric polymers used in the present composition preferably exhibit a molecular weight within the range of 8-14 million, preferably a molecular weight within the range from about 10 million to 15 million, and even more preferably within a range from about 10 million to about 12 million.

The first and second friction reducers are used in a concentration ratio in the fracturing fluid that is within the weight range of 1:2 to 2:1 and in a total mixture amount that is less than about 5% by weight, preferably less than about 2 wt %, and even more preferably in about 1 to about 10,000 parts per million based on the liquid present in the flowing mixture. More usually, the amount of polymer added is between about 5 and 1,000 parts per million and preferably from about 10 to about 500 parts per million.

The first and second friction reducers are used in a first FR to second FR weight ratio in the fluid within the range from about 1:1 to about 5:1, preferably within the range of 1:1 to about 3:1, even more preferably within the range of about 1:1 to about 1.5:1, and especially within a ratio of about 1:1.

The first and second friction-reducing agents may be used in the form of dewatered emulsions, standard emulsions, suspensions, or even a mixture of dry powders or a powder of one friction reducer suspended in an emulsion or suspension of the other friction reducer. Such powder forms are later hydrated before use.

Polyacrylamide emulsions are not simple concentrated solutions of polymer, so a simple dilution in water is not possible. When preparing a polymer solution from an emulsion, there are two physical phenomena (phase inversion and dissolution) which take place and need specific conditions to be made properly. When the emulsion comes in contact with water the inverting surfactant dissolves and emulsifies the oil in the water (inversion). Then the beads of hydrogel come in contact with water and dissolve (dissolution). Suspensions are preferred for their ability to hydrate and build to peak viscosity quickly.

Standard emulsions are also preferred for ease of mixing and speed of use. Those skilled in this art are, however, well acquainted with the form of friction reducer that is best suited to their equipment and systems.

The fluids for which the friction loss can be reduced in the process of the invention include those fluids which have a water phase, oil phase, and gas phase. The water and oil phases may be water and hydrocarbon slurries, emulsions, and micro emulsions or hydrocarbon and water slurries emulsions and micro emulsions. The hydrocarbon may be crude oils including viscous crudes having pour points above about 50° F., partially refined products of crude oil, refined products of crude oil, and any other liquid hydrocarbon materials. The oil phase may include any material containing carbon which is liquid at pipeline conditions, e.g. oils from shale, tar or coal. The oil phase may also contain comminuted solids.

The gas phase may comprise normally gaseous hydrocarbons such as those produced from an oil or gas formation, or may be an inert gas such as carbon dioxide which is often used as the gas drive in secondary recovery operation.

The process of the invention is particularly applicable to the reduction of friction loss in mixtures of water, crude oil and gas which often occur in the production of crude oil. For example, such mixtures are frequently encountered in production lines from oil producing areas both on shore and off shore. Such mixtures are also found in production lines from both water and gas injection systems in secondary recovery operations. Mixtures of this type are also encountered in water disposal systems in refineries and in production areas.

The use of a water soluble friction-reducing polymer in a three phase system of water, oil and gas can be used to increase oil production by lowering pressure at the well head. Another use includes the injection of a water soluble friction reducer into a pipeline moving quantities of oil, water and gas. The friction reducer allows the operator to reduce pressure in the line or increase the flow rate, or a combination of the two. Other uses include downhole injection to reduce friction in the oil well tubing.

The friction-reducing polymer is preferably injected into a flowing stream of the water/oil/gas mixture to facilitate mixing of the polymer in the flowing stream. This injection can be carried out using any of the types of apparatus disclosed for this use in the prior art.

The friction-reducing fluid of the present invention is used in virtually all the fracturing stage of a hydraulic fracturing treatment that uses produced backwater brine (or other source of water with a high TDS level) to initiate and propagate a fracture in the formation. This initial stage (called the “pad”) is free of proppant and is followed by a series of proppant-laden stages. The main fluid in these later, proppant-laden stages comprises one or more polymeric drag reducers such as the present mixture of anionic and amphoteric polyacrylamides.

If the treatment is a true “slickwater” application, there will only be a friction reducer in the water to reduce friction pressure and provide viscosity to help create fracture volume/width and transport proppant. There are treatments identified as “hybrid” that start out with a slickwater formulation (friction reducer only), then transition to a linear gel (possibly a guar gum or higher concentration of friction reducer) and then finally to a crosslinked polymer (usually a guar derivative). Hybrid treatments can also benefit by the present invention.

Friction reducers are normally added to the fracturing fluid “on the fly” as it is being pumped. If the friction reducer is in a liquid form small metering pumps will be used to proportion the additive into the fracturing fluid at the correct concentration. If the friction reducer is in a dry form it is often dissolved into water using a special piece of equipment identified as a “hydration unit” prior to being metered into the fracturing fluid during pumping operations.

Proppants suitable for use with the present invention include appropriately sized sand, ceramic, and bauxite. Such proppant solids may or may not carry an external coating designed to add functionality to the proppant solid.

The friction-reducing compositions of the present invention are particularly suitable for use with proppants that have a hydrophobic coating. Such coatings, as described in published application US 2016/0333258 include a proppant core (such as sand, ceramic, and bauxite) that are coated with a compatibilizing agent or bond promoter and a polymeric hydrophobic coating. Preferred hydrophobic coatings comprise a cured polybutadiene, a copolymer, a graft polymer, and a polyolefin such as the nonpolar, amorphous, polyalphaolefin sold by Evonik under the name VESTOPLAST W-1750. Proppants coated with such hydrophobic polymers exhibit an affinity to gas bubbles rather than liquids thereby helping to reduce their effective densities in use when placing proppants in a fractured subterranean stratum.

In the present invention, the friction-reducing composition of the invention is added to one or more of the proppant-laden stages. The present composition both helps to reduce friction pressure during the pumping operations and suspend the proppant in the frac fluid.

The in-situ generation of nitrogen gas volumes during formation stimulation can be accomplished by the sequential or simultaneous introduction of reactive components that generate gas as a product of their interaction. For example, sodium nitrite (as a first reactant) and ammonium chloride (as a second reactant) react or otherwise chemically interact at typical downhole conditions, e.g., 45°-100° C., and produce nitrogen and sodium chloride.

The first and second reactants should be well mixed by the time they enter the fracture field. Preferably, the time to gas generation is controlled to maximize the transport of the hydrophobic proppant into the desired locations within the fractured or fracturing field, e.g., the salts are mixed and the reaction rate has proceeded sufficiently that a sufficient amount of nitrogen is generated during the trip down that, by the time the slurry enters the fracture, the nitrogen bubble layer that reduces the proppant density is in place and helps to maximize the proppant transport within the fractured field.

### EXAMPLES

The suspension capabilities of various formulations were screened with a glass blender containing the test fluid and a standard volume of FloPRO test proppants of a standard size. The blender was turned on and allowed to mix under high shear conditions for a standard time. The blender is then turned off and the contents allowed to stop moving. The amount that remains floating and/or otherwise suspended in the liquid as a cloudiness represents a rough measure of the suspensive properties of the tested system. It should be understood that, in actual use, a proppant is subjected to shear forces and movement down the borehole into the fractured stratum for substantial distances. The screening test above is, therefore, only a rough screening test that is not intended to replicate the efficacy of the suspension fluid under actual use. The detailed test procedure was as follows:
1. Add the concentration of the friction reducer to be evaluated into a blender containing 500 ml of water and mix at 1500 RPM for 5 minutes.
2. Add (to the hydrated friction reducer) 120 gm of hydrophobic coated 20/40 sand (equivalent to 2 lb/gal).
3. Mix at 4500 RPM for 3 minutes to represent the shear history of a sand slurry being pumped down the treating string to the fracture opening.
4. Stop the mixer and wait one minute to allow the suspension of coated sand to stabilize.
5. Estimate the percentage of sand that is held in suspension.

Mixing the proppant and fluid at 4500 RPM for 3 minutes simulates fluid being pumped at 40 BPM through 8400 ft. of 4 ½″ casing. This statement is based on the following calculations:

$$Fluid velocity = \frac{( Ba \text{/} min ) \times ( 5.61 {ft}^{3} \text{/} Ba ) \times ( min \text{/} 60 sec )}{Cross \text{-} sectional area of pipe ( π \times {( pipe radius / 12 )}^{2} )} = \\ Fluid Velocity = \frac{40 \times 5.61 \times 1 / 60}{3.1417 {( 1.915 / 12 )}^{2}} = \frac{3.74}{.080 {ft}^{2}} {ft}^{3} \text{/} sec = 46.75 ft \text{/} sec$$

$$Distance Traveled = Velocity \times Time = 46.75 ft \text{/} sec \times 180 seconds = 8 \text{,} 415 ft$$

$$Shear Rate ( in pipe ) = \frac{8 \times Velocity ( ft \text{/} sec )}{Pipe diameter ( ft )} = \frac{8 \times 46.75}{3.83 / 12} = 1171.8 {sec}^{- 1}$$

$$Shear rate in blender @ 4500 RPM$$

$$\begin{matrix}Shear Rate = \frac{2 \times π \times Mixer blade radius \times RPM \text{/} 60}{Blender jar radius - Mixer blade radius} = \\ \frac{( 2 ) ( 3.1417 ) ( 1.1875 ) ( 75 )}{1.666 - 1.1875} \\ = 1169.5 {sec}^{- 1}\end{matrix}$$

Examples 1-4 report a screening test that measures suspensive capabilities by visual means, i.e., how much of the proppant remains floating or suspended in the test liquid after the agitation is removed.

### Example 1

Example 1 shows the effects of brine on the suspension of 20/40 mesh FloPRO in a system without a friction reducer. As shown by table 1, the FloPRO coated sand is relatively unaffected by the increased TDS content of the sample water. The API brine has 8% by weight sodium chloride and 2.5% calcium chloride by weight for a solids content of 110,000 ppm TDS. This is considered a high TDS brine.

TABLE 1
No Additives

| Mixture | Vol % Suspended |
|---|---|
| Tap water (low TDS) | About 50% suspended |
| API brine (high TDS) | About 70% suspended |

The proppant suspension properties of the hydrophobic coating alone are not greatly affected by increases in TDS. In fact, the hydrophobic coating improved with increased TDS, but will not have the benefit of reduced friction as it is injected down the borehole into the fracture field.

### Example 2

The additives that are used in a fracturing treatment to carry and place the hydrophobic coated proppant into a hydraulically created fracture are, however, affected by the TDS of the brine.

Hydrophobic coatings such as those used on the FloPRO product are incompatible with cationic friction reducers which are resistant to brine TDS. Thus, the most brine-tolerant friction reducers are not an option. Anionic friction reducers are compatible with hydrophobically coated proppants but are generally adversely affected by increased TDS.

Even the high molecular weight anionic friction reducer that aided suspension properties in low TDS tests is relatively ineffective in maintaining suspension properties when used in a high TDS fluid, such as an API brine of 110,000 ppm TDS. Shown below in Table 2 are the suspension test results of a 20/40 FloPRO treated sand in API brine containing an anionic friction reducer.

TABLE 2

| Mixture in API brine | Vol % Suspended |
|---|---|
| 1.25 gpt standard anionic friction reducer | About 30% |
| 1.25 gpt high MW anionic friction reducer | About 40% |

Neither the standard or the high molecular weight anionic friction reducer exhibited acceptable suspensive properties.

### Example 3

The initial thought was that the high TDS of the brine was interfering with the uncoiling of the anionic polyacrylamide friction reducer polymers and thereby preventing its maximum viscosity but also any suspension benefits from the polymer structure. To address this possibility, a variety of nonionic and one amphoteric polyacrylamide were tested. The suspension test results from the use of API brine with 20/40 FloPRO treated sand and the nonionic/amphoteric friction reducers at a concentration level of 4-5 ppt are shown below in Table 3.

TABLE 3

| Mixture | Suspension (vol %) |
|---|---|
| 4 ppt nonionic N-5141² | 0% in <30 seconds |
| 5 ppt nonionic NFRD³ | 0% in <30 seconds |
| 5 ppt amphoteric ZFRD³ | 0% in <30 seconds |

²The N-5141 friction reducer is a standard molecular weight (10-12 million MW) nonionic friction reducer made by Kemira in Houston, TX.
³The NFRD (nonionic) and ZFRD (amphoteric) are standard MW friction reducers that are available from PFP Industries in Houston, TX.

All three of the above samples had close to 100% suspension of the 20/40 FloPRO treated sand initially, but the suspended 20/40 dropped to the bottom of the sample jar in <30 seconds.

### Example 4

Example 4 presents data for suspension tests performed using FloPRO coated 20/40 sand and combinations of high molecular weight anionic polyacrylamide (e.g., POLYglide A-FRE-4) and a nonionic or amphoteric polyacrylamide (e.g., N-5141, N-5142, N-5144, NFRD, FloJET, or ZFRD). The results are shown in Table 4.

TABLE 4

| | Suspension |
|---|---|
| Mixture | (vol %) |
| 0.75 gpt POLYglide A-FRE-4¹ (anionic) + | 80% |
| 2 ppt N-5141² (nonionic) | |
| 0.75 gpt POLYglide A-FRE-4¹ (anionic) + | 80% |
| 2 ppt N-5142² (nonionic) | |
| 0.75 gpt POLYglide A-FRE-4¹ (anionic) + | 80% |
| 2 ppt N-5144² (nonionic) | |
| 0.75 gpt POLYglide A-FRE-4¹ (anionic) + | 90% |
| 2 ppt NFRD³ (nonionic) | |
| 0.75 gpt POLYglide A-FRE-4 (anionic) + | 75-80% |
| 2 ppt FloJET DR 7000 (nonionic) | |
| 0.75 gpt POLYglide A-FRE-4 (anionic) + | 75-80% |
| 2 ppt ZFRD³ (amphoteric) | |

¹The POLYglide A-FRE-4 is a high molecular weight (>15 million MW), anionic friction reducer available from PFP Industries in Houston, TX.
²The N-5141, 5142 and 5144 are standard molecular weight, anionic friction reducers made by Kemira in Houston, TX.
³The NFRD (nonionic) and ZFRD (amphoteric) are standard MW friction reducers that are available from PFP Industries in Houston, TX.
⁴The FloJET DR 7000 is a standard MW, nonionic friction reducer from SNF Oil & Gas of Riceboro, GA.

As far as proppant suspension of FloPRO coated sand goes, it seems to make little difference whether you use a nonionic or amphoteric polyacrylamide in combination with the high molecular weight anionic friction reducer. All the nonionic/amphoteric samples (in combination with A-FRE-4 or FR-904) looked better than the high molecular weight anionics, nonionic or amphoteric by itself.

### Example 5

Example 5 uses a test method of greater reproducibility based on the minimum amount of shear needed to maintain an uncoated proppant in suspension. The test procedure was as follows:
a) Add the desired concentration of the friction reducer to be evaluated into a blender containing 500 ml total of fresh water and brine (1:1 ratio) and mix at 1500 RPM for 5 minutes
b) Add 120 gm of the 20/40 uncoated sand to be evaluated (equivalent to 2 lb/gal) to the hydrated polymer solution and continue mixing until the sand is evenly distributed.
c) Adjust the mixer RPM to achieve the lowest setting that will minimize the buildup of sand that is dropping out of the slurry.
d) Record the RPM value that achieved the desired result in Step c). Lower RPM values represent a greater suspensive character during proppant injection conditions.

Using this test procedure, the results shown in Table 5 were obtained. The results show the average of two tests. Half of the suspension tests were performed in a 50:50 mix of the tap water and a synthetic brine. The brine had a TDS of 181,309 ppm so a 50:50 blend would still have a TDS of at least 90,000 ppm.

TABLE 5

| | Lowest RPM to Keep | | | |
|---|---|---|---|---|
| | Proppant in Suspension | | | |
| Friction Reducer | 1 gpt | 2 gpt | 3 gpt | 4 gpt |
| anionic polyacrylamide A | 961 | 890 | 814 | 725 |
| anionic polyacrylamide B | 829 | 780 | 720 | 712 |
| POLYglide A-FRE-4¹ (anionic) | 868 | 768 | 674 | 642 |
| 0.5 gpt POLYglide A-FRE-4¹ (anionic) + | 747 | | | |
| 2 gpt ZFRD (amphoteric)³ | | | | |

¹The POLYglide A-FRE-4 is an anionic friction reducer product available from PFP Industries in Houston, TX.
³The ZFRD (amphoteric) is a standard MW friction reducer that is available from PFP Industries in Houston, TX.

Example 5 compares the suspension properties of the friction reducers with uncoated sand, i.e., without a hydrophobic coating. Given that fact the table was reduced to measurements made at the same additive concentration (1 gpt). The mixture of A-FRE-4 and ZFRD contains the same polymer concentration as the 1 gpt A-FRE-4 by itself.

This data confirms that the advantage of using the high MW and standard MW combination is not limited to applications that include the FloPRO coated sand. It confirms that in a high TDS brine solution there is superior proppant suspension properties compared to any anionic friction reducer tested alone.

The friction reducer mixture of the high molecular weight anionic friction reducer and the nonionic friction reducer in a high TDS brine that showed the best results in uncoated sand suspension tests also showed improved suspension when used in combination with the hydrophobic, coated sand and a high TDS brine.

### Example 6

Example 6 reports on comparative tests done on each nonionic polymer individually compared to the mixture of the two according to the invention. In particular, this table compares a high molecular weight anionic (FR-904), a non-ionic and the combination of the two using an uncoated sand suspension test. Each test used API brine of 100,000 TDS. Each friction reducer composition was used at a loading of 4 ppt. See Table 6.

TABLE 6

| | Polymer Concentration | Lowest RPM to |
|---|---|---|
| Friction Reducer | (wt) | Suspension Failure |
| POLYglide FR-904⁵ | 4 ppt | 874 |
| NFRD³ | 4 ppt | 899 |
| POLYglide FR-904 + | 2 ppt + 2 ppt | 843 |
| NFRD³ | | |

The POLYglide FR-904 is a high molecular weight anionic friction reducer made by PFP Industries in Houston, Tex.

The NFRD (anionic) is a standard MW friction reducer that is available from PFP Industries in Houston, Tex.

The results in Table 6 show that the combination of the two friction reducers exhibits a better suspensive effect than either agent alone at the same overall concentration.

### Example 7

Examples 7 uses nitrogen created through the reaction of two salt in solution “on the fly” to test the functionality of this method during proppant pumping operations. This approach will utilize standard mixing and pumping equipment that the service company can readily and inexpensively make available for the fracturing treatment. This eliminates the need for a nitrogen service to be on site which both complicates the treatment's execution and significantly increases overall treatment costs. The salt solutions that are mixed and pumped with conventional equipment are much less expensive than brining liquefied nitrogen to the location and pumping it with the high pressure nitrogen pumping equipment.

To show the validity of this approach we will utilize the same suspension test procedure that was used to illustrate the value of mixing an anionic and nonionic friction reducers to aid the suspension of the FloPRO coated sand in brines. The procedure is as follows:

a) Add the friction reducer (to be incorporated in the suspension test) to 500 ml of water and mix for 5 minutes at 1500 RPM.

b) Add 120 gm of the FloPRO sand (to be evaluated) into the blender containing the sample from Step #1 and mix at 4500 RPM for 3 minutes. This concentration represents a proppant concentration of 2 pounds per gallon. The mixing step is representative of the high shear trip though tubular goods before reaching the fracture.

c) After the three minutes of shear/mixing stop the blender and let stand for 1 minute.

d) After completion of 1 minute period photograph the sample to record the suspension results and estimate the amount of suspended particles as a percentage of the proppant sample added in Step #2.

In this procedure, the high speed mixing step results in air being sucked into the blender and mixed with the slurry. The presence of the air in place of the nitrogen in the slurry is used to form a bubble layer on the proppant surface area. It is the establishment and the retention of this bubble layer that is believed to allow the proppant to remain suspended when the mixing of the sample is stopped. The blender jar is left uncovered and thereby free to entrain air into the sample. The sample volume is selected so that the sand fills no more than approximately half the volume of the blender jar. Using too big a sample relative to the size of the blender jar will restrict the amount of air that will be mixed into the sample and eventually used in the bubble layer.

A test of the suspension test procedure above was done with 30/50 mesh FloPro hydrophobically coated sand and 1 gpt POLYglide A-FRE-4 high molecular weight friction reducer/suspension agent in tap water (low TDS). After shearing/mixing at 4500 RPM, this sample showed 100% suspension of the 30/50 FloPRO coated particles.

The test was repeated keeping all aspects of the test unchanged except that the volume of tap water was increased from 500 ml to 900 ml. At the greater volume of water, there was minimum space between the fluid level in the jar and the top of the blender jar. Also during the test there was a lid placed on the jar to minimize the amount of air that was available to be sucked into the test sample. The goal of this test was to establish the need to have air sucked into the blender during the high-speed portion of the mixing so that gas was available to form the bubble layer on the sand particle's surface area that results in the sand staying suspended after mixing is completed. This altered procedure the test was repeated still utilizing 1 gpt POLYglide A-FRE-4 and 30/50 FloPRO coated sand.

Limiting the availability of air during high speed mixing resulted in almost none of the FloPRO coated particles being suspended after mixing had stopped.

### Example 8

To illustrate the utility of generating gas to form a bubble layer that leads to the suspension of the proppant grains, the altered procedure that led to no suspended particles in Example 7 was used but with the generation of a nitrogen gas formed in-situ from the reaction of 86 grams of ammonium chloride and 110.9 grams of sodium nitrite. These weights represent an equal mole ratio of the two components. The reaction between the two salts was catalyzed by the addition of 5 grams of acetic acid. The test procedure is as follows:

a) The sample volume was 900 ml of tap water that was split into two components.

b) A 700 ml portion was used to hydrate 1 gpt POLYglide A-FRE-4 as well as contain the ammonium chloride and acetic acid.

c) The sample was mixed for 5 minutes at 1500 RPM.

d) After a 5-minute period used to hydrate the friction reducer, a 200 ml portion of water containing the sodium nitrite and 120 grams of FloPRO 30/50 mesh sand are added while increasing the mixer speed to 4500 RPM. The blender lid was held tightly in place on the mixer.

e) At the end of 3 minutes, the 4500 RPM mixing was stopped and the suspension of particles observed.

The test showed that the generation of the nitrogen from a reaction of salts can provide sufficient gas to facilitate the suspension of virtually all of the FloPRO coated 30/50 sand. It was also observed that the reaction continued for approximately one hour which is a time that is like the pumping time associated with a stage of a fracturing treatment so the effect has the ability to work in an actual fracturing operation. The ongoing availability of nitrogen to replace any uncovered surface area that might be exposed during the pumping operation was felt to be an added benefit.

What is claimed is:

1. A polymeric friction-reducing composition useful when treating a subterranean formation penetrated by a wellbore that has been stimulated with a brine fracturing fluid having 50,000 ppm total dissolved solids or more and a proppant, said polymeric friction-reducing composition comprising a mixture of polymeric friction reducers comprising (a) a first friction reducer that comprises a high molecular weight, anionic, polymeric friction reducer having a molecular weight above 15 million and (b) a second friction reducer that comprises either a nonionic or an amphoteric polymeric friction reducer, a concentration ratio of said first friction reducer to said second friction reducer in said fracturing fluid that is within the range of 3:1 to 1:1 and in a total mixture amount that is less than about 5% by weight of the brine fracturing fluid.

2. A composition according to claim 1 wherein the concentration ratio of said first friction reducer to said second friction reducer in said fracturing fluid is within the weight range of about 1:2 to about 2:1.

3. A method for stimulating a subterranean field by a process that comprises:
introducing proppant into said subterranean field with brine and a polymeric friction-reducing composition that comprises a mixture of polymeric friction reducers comprising (a) a first friction reducer that comprises a high molecular weight, anionic, polymeric friction reducer having a molecular weight above 15 million and (b) a second friction reducer that comprises either a nonionic or an amphoteric polymeric friction reducer, a concentration ratio of said first friction reducer to said second friction reducer in said fracturing fluid that is within the range of 5:1 to 1:1 and in a total mixture amount that is less than about 5% by weight of the brine fracturing fluid.

4. A method according to claim 3 wherein said proppant comprises sand.

5. A method according to claim 4 wherein said proppant comprises a hydrophobic coating with an attraction or affinity to catch and retain gas bubbles.

6. A method according to claim 3 wherein said polymeric friction-reducing composition comprises (a) said first friction reducer and (b) a second friction reducer that comprises a nonionic polymeric friction reducer.

7. A method according to claim 3 wherein said polymeric friction-reducing composition comprises (a) said first friction reducer and (b) a second friction reducer that comprises an amphoteric polymeric friction reducer.

8. A method according to claim 3 wherein said high molecular weight, anionic, polymeric friction reducer has a molecular weight within the range from about 18 million to about 40 million.

9. A method according to claim 3 wherein said high molecular weight, anionic, polymeric friction reducer has a molecular weight within a range from about 18 million to about 25 million.

10. A method according to claim 3 further comprising:
introducing a first reactant and a second reactant into said subterranean field with said polymeric friction-reducing composition whereby said first reactant and said second reactant chemically react to produce nitrogen gas that becomes associated with a hydrophobically-coated proppant during transport into said subterranean field.

11. A method according to claim 10 wherein said first reactant is substantially mixed with said second reactant upon entry to the subterranean field.

12. A method according to claim 10 wherein said first reactant comprises sodium nitrite and said second reactant comprises ammonium chloride.
